(19) United States
(12) Patent Application Publication
(10) Pub. No.: US 2005/0271930 A1
(43) Pub. Date: Dec. 8, 2005

(54) Polymer electrolyte fuel cell and manufacturing method thereof

(75) Inventor: Takashi Egawa, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: JAPAN STORAGE BATTERY CO., LTD., Kyoto-shi (JP)

(21) Appl. No.: 11/084,200

(22) Filed: Mar. 21, 2005

(30) Foreign Application Priority Data
Mar. 22, 2004 (JP) 2004-083366

(51) Int. Cl. H01M 4/96; H01M 4/92; H01M 4/88

(52) U.S. Cl. 429/42; 429/44; 502/101

(57) ABSTRACT

A polymer electrolyte fuel cell comprises a catalyst layer; a cation exchange resin provided in the catalyst layer; a proton conductive path provided in the cation exchange resin; a carbon material provided in the catalyst layer; and a catalyst metal provided in the catalyst layer. 50 mass % or more of the catalyst metal is loaded on the contact surface between the proton conductive path and the carbon material, and the porosity of the catalyst layer is 65% to 87.5%.

### FIELD OF THE INVENTION

The present invention relates to a polymer electrolyte fuel cell and a manufacturing method thereof.

### BACKGROUND OF THE INVENTION

A polymer electrolyte fuel cell (hereinafter called the “PEFC”) basically generates only water as its reaction product. Therefore, the PEFC has been observed as an electrical generating system which exerts almost no negative influence. In recent years, the PEFC, which uses a cation exchange membrane as an electrolyte, has attracted attention as a power source for vehicles due to its low operating temperature, high power density and its miniaturizability.

A single cell of the PEFC has a structure in which an assembly of a cation exchange membrane and a catalyst electrode (hereinafter called the “cation exchange membrane-catalyst electrode assembly”) is held by a pair of separators. The cation exchange membrane-catalyst electrode assembly is configured by joining an anode to one side of the cation exchange membrane, and a cathode to the other side. Gas flow channel processing is provided on the separator. For example, electric power can be obtained by supplying hydrogen to the anode as a fuel and oxygen to the cathode as an oxidizer. In this configuration, the following electrochemical reactions proceed at the anode and cathode, respectively.

Anode: 2H₂→4H⁺+4e−

Cathode: O₂+4H⁺+4e−→2H₂O

Altogether: 2H₂+O₂→2H₂O

As is clear from these reaction formulas, the reaction of each electrode proceeds only at an interface where gas as an active material (hydrogen or oxygen), a proton (H⁺), and electron (e⁻) can be transferred simultaneously (hereinafter the interface called the “reactive interface”).

The electrode of the PEFC comprises the cation exchange membrane-catalyst electrode assembly in which a catalyst layer is positioned on both sides of the cation exchange membrane; and a conductive porous media which is a water-repellent treated carbon paper or the like. In the catalyst layer, a carbon powder loading a catalyst metal and a cation exchange resin are mixed together so as to be distributed three-dimensionally with a plurality of pores. In the catalyst layer, the multitudinous reactive interfaces which can transfer gas, a proton (H⁺), and an electron (e⁻) simultaneously are formed.

The electrode of the PEFC is manufactured by preparing a mixture of carbon loading platinum as a catalyst metal and a cation exchange resin solution, and then by directly applying the mixture to the surface of the cation exchange membrane or the conductive porous media and drying, or transferring the mixture applied to another sheet substrate and dried, on the cation exchange membrane (M. S. Wilson, Journal of Applied Electrochemistry, 22, 1 (1992)). It is reported, in Edson A. Ticianelli, Journal of Electroanalytical Chemistry, 251, 257 (1988), that since the electrode has catalyst metal elsewhere than the reactive interface, the utilization factor of the metal is considerably low. Therefore, in a conventional case, a large amount of the catalyst metal is required since the utilization factor of the catalyst metal is low. A method for improving the utilization factor is disclosed in 2000-012040A of the Japanese Published Patent Application. It is known that since the method can selectively load a catalyst metal on the contact surface between a proton conductive path of the cation exchange resin and the surface of a carbon material, the utilization factor thereof is higher than in a case of conventional electrodes for the PEFC. However, since the power of the PEFC by using the electrode obtained in this method is low, there is a drawback in that the PEFC lacks in practicality. The causes have been unexplained and improvement of the performance of the PEFC has been strongly desired.

### SUMMARY OF THE INVENTION

Through a series of experiments, the inventors keenly examined why the power of the PEFC which has a catalyst layer selectively loading a catalyst metal on the contact surface between a proton conductive path of the cation exchange resin and the surface of a carbon material is low. It is clear from the results that the low power mainly arises from low diffusibility of the gas in the catalyst layer and low expelling property of the generated water to outside the system. Specifically, since the catalyst layer expels the water generated in a reaction to outside the system with difficultly, the water turns to droplets to block a gas diffusion path. Accordingly, the water prevents hydrogen gas or oxygen gas as an active material from reaching the reactive interface from outside the system. As a result, since no reaction is produced at the reactive interface which the gases do not reach, deviation of current density occurs. It is conceivable that the power of the PEFC consequently decreases. Therefore, in order to put the catalyst layer into practical application, it is crucial to improve the gas diffusibility and the water expelling property in the catalyst layer. It is an object of the present invention to provide a polymer electrolyte fuel cell in which the gas diffusibility and the water expelling property in the catalyst layer of the PEFC are improved and a manufacturing method thereof.

The present invention comprises a catalyst layer; a cation exchange resin provided in the catalyst layer; a proton conductive path provided in the cation exchange resin, a carbon material provided in the catalyst layer; and a catalyst metal provided in the catalyst layer, wherein 50 mass % or more of the catalyst metal is loaded on the contact surface between the proton conductive path and the carbon material, being based on the fact that the power of the PEFC whose catalyst layer porosity is >65% and <87.5% is remarkably improved compared to conventional ones.

A first aspect of the present invention is a polymer electrolyte fuel cell which comprises a catalyst layer; a cation exchange resin provided in the catalyst layer; a proton conductive path provided in the cation exchange resin; a carbon material provided in the catalyst layer; and a catalyst metal provided in the catalyst layer, wherein 50 mass % or more of the catalyst metal is loaded on the contact surface between the proton conductive path and the carbon material; and the porosity of the catalyst layer is >65% and <87.5%.

Since the catalyst layer of the PEFC according to the first aspect of the present invention is provided with pores at a ratio of >65% and <87.5%, the gas diffusibility of hydrogen, air or the like in the catalyst layer and the expelling property of water generated by cathode electrode reaction or the like are improved. The improvement of the gas diffusibility and the water expelling property enables an increase in the polarization of the PEFC to be suppressed even under a condition in which current density or utilization factor of fuel and oxygen is high. Therefore, a fuel cell of high power density can be provided.

A second aspect of the present invention is a manufacturing method of a polymer electrolyte fuel cell which comprises the following processes: a first process for substituting a cation of a catalyst metal for a cation exchange resin having a fixed anion bonded with a hydrogen ion and a hydrogen ion in a mixture with a carbon material, in a solution; a second process for decreasing the hydrogen ion concentration of the solution after the first process; a third process for reducing the cation after the first process so as to manufacture a mixture X containing a cation exchange resin, a carbon material and a catalyst metal; a fourth process for curing a slurry which contains the mixture X, a substance soluble in acid and a solvent, applied onto a substrate after the second and third processes so as to manufacture a layered product of a catalyst layer containing the substance, and the substrate; a fifth process for joining the catalyst layer to a cation exchange membrane after the fourth process so as to manufacture an assembly of the cation exchange membrane and a catalyst electrode; and a sixth process for bringing the catalyst layer into contact with acid after the fifth process so as to dissolve the substance.

According to the second aspect of the present invention, since the catalyst layer is formed containing a substance soluble in acid and the substance is then dissolved in acid, the catalyst layer can become porous. In the first process of the second aspect, since the hydrogen ion substituted by a cation of the catalyst metal is discharged from the cation exchange resin into a solution, the solution becomes acidic. However, since the second process decreases the hydrogen ion concentration of the solution, the “substance soluble in acid” used in the fourth process does not dissolve until it comes into contact with acid in the sixth process after the slurry is cured in the fourth process. As a result, the substance soluble in acid can function well as a pore-forming additive. Furthermore, when joining the catalyst layer to the cation exchange membrane in the fifth process, the substance soluble in acid is located in the catalyst layer. Therefore, since the catalyst layer is joined to the cation exchange membrane before becoming porous, the catalyst layer is hardly collapsed even when being strongly pressed to the cation exchange membrane for joining. Furthermore, since the catalyst layer is joined to the cation exchange membrane in the fifth process after the catalyst is loaded in the catalyst layer in the first and third processes, the mixing of the catalyst metal into the cation exchange membrane is suppressed, which is different from a case of the reverse procedure.

### BRIEF DESCRIPTION OF THE DRAWING

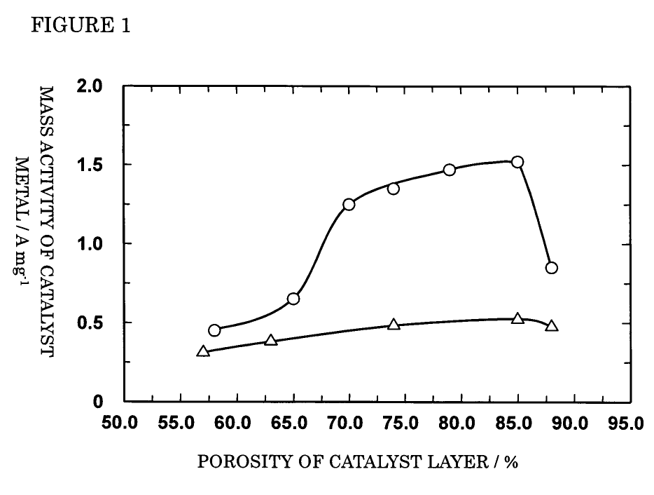

The FIG. 1 shows the relation between the porosity of the catalyst layer and the mass activity of the catalyst metal in Examples 1 to 6 and Comparative Example 1, and in Comparative Examples 2 to 6.

### DETAILED DESCRIPTION OF THE INVENTION

The invention of this application is hereinafter described in further detail by way of embodiments of the present invention.

The present invention relates to a polymer electrolyte fuel cell and a manufacturing method thereof.

A first aspect of the present invention is a polymer electrolyte fuel cell which comprises a catalyst layer; a cation exchange resin provided in the catalyst layer; a proton conductive path provided in the cation exchange resin; a carbon material provided in the catalyst layer; and a catalyst metal provided in the catalyst layer, wherein 50 mass % or more of the catalyst metal is loaded on the contact surface between the proton conductive path and the carbon material, and the porosity of the catalyst layer is >65% and <87.5%.

The porosity of the catalyst layer in the PEFC of the present invention is >65% and <87.5%. Since the gas diffusibility of hydrogen, air or the like and the expelling property of generated water are preferable within this range, a PEFC decreasing polarization can be obtained. When the porosity of the catalyst layer is less than 65%, the gas diffusibility or generated water expelling property in the catalyst layer decreases significantly. When the porosity of the catalyst layer is more than 87.5%, the contact resistance between carbon materials increases thereby increasing the polarization of the PEFC.

The porosity of the catalyst layer according to the specification of this application is obtained as follows. Firstly, moisture contained in the catalyst layer is removed by drying. Then, the cross section thickness of the catalyst layer is measured by a scanning electron microscope (SEM). Next, based on the mass and true density of each material used in the catalyst layer, the volumes which the materials account for are calculated. Furthermore, the value obtained by deducting the volume which each material accounts for from the catalyst layer volume obtained from the catalyst layer thickness measured by the SEM is let to be a pore volume. Lastly, the porosity is calculated by dividing the pore volume by the catalyst layer volume.

A second aspect of the present invention is a manufacturing method of a polymer electrolyte fuel cell which comprises the following processes: a first process for substituting a cation of a catalyst metal for a cation exchange resin having a fixed anion bonded with a hydrogen ion and a hydrogen ion in a mixture with a carbon material, in a solution; a second process for decreasing the hydrogen ion concentration of the solution after the first process; a third process for reducing the cation after the first process so as to manufacture a mixture X containing a cation exchange resin, a carbon material and a catalyst metal; a fourth process for curing a slurry which contains the mixture X, a substance soluble in acid and a solvent applied onto a substrate after the second and third processes so as to manufacture a layered product of a catalyst layer containing the substance, and the substrate; a fifth process for joining the catalyst layer to a cation exchange membrane after the fourth process so as to manufacture an assembly of the cation exchange membrane and a catalyst electrode; and a sixth process for bringing the catalyst layer into contact with acid after the fifth process so as to dissolve the substance.

The expression “substitute a cation of a catalyst metal for a hydrogen ion” in the first process not only means a case in which a hydrogen ion is directly substituted by a cation of a catalyst ion, but also includes a case in which a hydrogen ion is substituted by another cation and the cation is then substituted by a cation of a catalyst metal.

Concrete examples of the method for “decreasing the hydrogen ion concentration of the solution” in the second process include the method by cleaning with a liquid of lower hydrogen ion concentration than the solution (deionized water or the like) and the method by volatilizing volatile acid from the solution.

Concrete examples of the method for “curing” in the fourth process include the method by removing a solvent by drying.

The expression “dissolve the substance” in the sixth process does not necessarily mean that the whole substance has to be dissolved, only a part of the substance is enough to be dissolved as long as a sufficient porosity can be obtained.

According to the second aspect, since the catalyst layer is formed containing a substance soluble in acid and the substance is then dissolved in acid, the catalyst layer can become porous. In the first process of the second aspect, since the hydrogen ion substituted by a cation of the catalyst metal is discharged from the cation exchange resin into a solution, the solution becomes acidic. However, since the hydrogen ion concentration of the solution is decreased in the second process, the “substance soluble in acid” used in the fourth process does not dissolve until it comes into contact with acid in the sixth process after the slurry is cured in the fourth process. As a result, the substance soluble in acid can function well as a pore-forming additive. Furthermore, when joining the catalyst layer to the cation exchange membrane in the fifth process, the substance soluble in acid is located in the catalyst layer. Therefore, since the catalyst layer is joined to the cation exchange membrane before becoming porous, the catalyst layer is hardly collapsed even when being strongly pressed into the cation exchange membrane for joining. Furthermore, since the catalyst layer is joined to the cation exchange membrane in the fifth process after the catalyst is loaded by the catalyst layer in the first and third processes, the mixing of the catalyst metal into the cation exchange membrane is suppressed, which is different from a case of the reverse procedure.

Examples of the method for manufacturing a cation exchange membrane-catalyst electrode assembly include the method by preparing a slurry containing a cation exchange resin, a carbon material and a catalyst metal and then by directly applying the slurry onto the surface of a cation exchange membrane or a conductive porous media and drying, or the method by transferring the slurry applied onto another sheet substrate and dried, on a cation exchange membrane. Among these methods, although the method of direct application onto the surface of a cation exchange membrane or a conductive porous media and drying can maintain relatively high porosity, it has difficulty in controlling the porosity of the catalyst layer within the range of >65% and <87.5%. Accordingly, the present invention, based on the experimental result keenly examined about controlling the porosity of the catalyst layer within the range of >65% and <87.5%, demonstrates that the porosity of the catalyst layer can be controlled by using a substance soluble in acid and changing the amount thereof. The present invention further demonstrates that the pore size distribution of the catalyst layer can be controlled by changing the size of the substance soluble in acid. Therefore, the manufacturing method of the present invention is preferable for controlling the porosity of the catalyst layer in the cation exchange membrane-catalyst electrode assembly within the range of >65% and <87.5%.

The manufacturing method of the PEFC of the present invention in which the mass of the catalyst metal loaded by the contact surface between a proton conductive path of a cation exchange resin and a carbon material is 50 mass % or more of the total mass of the catalyst metal, having a catalyst layer whose porosity is >65% and <87.5%, preferably comprises the following six processes. Specifically, process (a) for drying and crushing a dispersion of a carbon material and a cation exchange resin solution so as to manufacture a mixture of the carbon material and the cation exchange resin; process (b) for adsorbing a cation of the catalyst metal to a fixed ion of the cation exchange resin in the mixture obtained in process (a); process (c) for reducing the cation of the catalyst metal so as to manufacture a mixture X containing the cation exchange resin, the carbon material and the catalyst metal; process (d) for applying a slurry containing the mixture X, a substance soluble in acid and a solvent onto a sheet and drying so as to manufacture a layered product of a catalyst layer containing the mixture X and the substance soluble in acid, and the sheet; process (e) for joining the catalyst layer to a cation exchange membrane from the layered product so as to obtain a cation exchange membrane-catalyst electrode assembly; and process (f) for bringing the cation exchange membrane-catalyst electrode assembly into contact with acid.

In process (a) of the manufacturing method of the PEFC of the present invention, a mixture of a carbon material and a cation exchange resin can be manufactured by drying and crushing a dispersion of a carbon material and a cation exchange resin solution.

For the carbon material used in process (a), ones which have high electronic conductivity are preferable, and for example, carbon black such as acetylene black and furnace black and active carbon can be used. Carbon black such as Denka Black, Vulcan XC-72, Black Peal 2000 or Ketjenblack EC is preferably used.

For the cation exchange resin used in process (a), resins which have proton conductivity, for example, cation exchange resins of perfluorocarbon sulfonic acid type or styrene-divinylbenzenesulfonic acid type, or cation exchange resins of carboxylic acid type can be used. For the solvent for dissolving the cation exchange resins, a mixture of water and alcohol at an arbitrary ratio can be used. The viscosity of the mixture changes according to the amount of the solvent of the cation exchange resin. Therefore, various viscosities of the mixture can be adjusted by selecting the concentration of the cation exchange resin. For example, when the concentration of the cation exchange resin is high, the viscosity can be reduced by adding water, alcohol, alcohol solution or the like to the mixture.

For the drying method in process (a), in addition to exposure drying and spray drying, an air blow dryer, a warm air dryer, an infrared heater, a far-infrared heater or the like can be used, but not being limited to a specific drying method. For the crushing method in process (a), in addition to a ball-milling and a roll mill, a chaster mill or the like can be used, but not being limited to a specific crushing method.

In process (b) of the manufacturing method of the PEFC of the present invention, a solution of a compound containing a metal to be the catalyst metal dissolved in water or water containing alcohol is preferably prepared. The solution contains a cation of the catalyst metal. Next, by immersing the mixture of the carbon material and the cation exchange resin manufactured in the first process in the solution, a cation of the catalyst metal is adsorbed to the cation exchange resin contained in the mixture. This adsorption is caused by the ion exchange reaction of the counter ion of the cation exchange resin and a cation of the catalyst metal. In this process, by using two kinds or more of cations to be ion-exchanged, two kinds or more of cations of the catalyst metal can be adsorbed to the mixture. Preferably, the cation of the catalyst metal has difficulty in being absorbed to the surface of the carbon material where the cation exchange resin is exposed without coating, and is preferentially adsorbed to the proton conductive path of the cation exchange resin by the ion exchange reaction with the cation of the cation exchange resin. As a cation to be a catalyst metal having such an adsorption character, a cation containing a platinum group metal or a complex ion of a platinum group metal can be used. For the complex ion, for example, an ammine complex ion of platinum which can be expressed as [Pt (NH₃)₄]²⁺, [Pt(NH₃)₆]⁴⁺ or the like, or [Ru(NH₃)₆]²⁺ or [Ru(NH₃)₆]³⁺ is preferable. Furthermore, in addition to the ammine complex ion, a complex ion of a platinum group metal in which a nitric acid group or a nitroso group is coordinated can be used. It is to be noted that the platinum group metal according to the specification of this application may be Pt (platinum), Pd (palladium), Rh (rhodium), Ru (ruthenium), Ir (iridium) and Os (osmium).

In process (c) of the manufacturing method of the PEFC of the present invention, preferably, a cation of the catalyst metal contained in the mixture of the carbon material and the cation exchange resin, manufactured in process (b) is chemically reduced. Through the reduction process, the mixture X which contains a cation exchange resin, a carbon material and a catalyst metal, in which the catalyst metal is selectively loaded on the contact surface between the surface of the carbon material and the proton conductive path of the cation exchange resin, can be obtained.

In process (c), a chemical reduction method using a reducing agent suitable for mass production is preferably applied. Particularly, the method by vapor phase reducing by hydrogen gas or a gas containing hydrogen, or the method by vapor phase reducing by an inert gas containing hydrazine is preferable. In this process, the gas containing hydrogen gas is preferably a mixed gas of hydrogen gas and an inert gas such as nitrogen, helium or argon, preferably containing 10 vol % or more of hydrogen gas.

In process (c), since the carbon material has catalytic activity for the reductive reaction of the cation of a platinum group metal, the cation of the catalyst metal contained in the cation exchange resin can be reduced even at a temperature of 200° C. or lower.

For example, the reduction temperature of a platinum ammine complex ion [Pt(NH₃)₄]²⁺ adsorbed into a perfluorocarbon sulfonic acid type cation exchange resin by hydrogen is about 300° C. (Tetsuo Sakai, Bulletin of the Osaka Industrial Research Institute, 36, 10 (1985)). On the contrary, it is reported that the reduction temperature of [Pt(NH₃)₄]²⁺ adsorbed to the surface of carbon particles modified by an exchange group (Denka Black, Vulcan XC-72, Black Pearl 2000 and the like) is 180° C. (K. Amine, M. Mizuhata, K. Oguro, H. Takenaka, J. Chem. Soc. Faraday Trans., 91, 4451 (1995)). Since the cation located adjacent to the surface of the carbon material is preferentially reduced to the catalyst metal in the result, a catalyst metal is produced on the surface of the carbon material. Since the produced catalyst metal has catalytic activity for the reductive reaction of the cation, the cations in the cation exchange resin are reduced to the catalyst metal one after another. In process (c), the particle size and surface quality of the catalyst metal produced on the surface of the carbon material can be controlled by adjusting the type of reducing agent, reducing agent concentration, reduction pressure, and reduction time on a timely basis.

In process (d) of the manufacturing method of the PEFC of the present invention, preferably, a slurry containing the mixture X obtained in process (c), a substance soluble in acid and a solvent is applied onto a sheet and dried, and a layered product of a catalyst layer containing the mixture X and the substance soluble in acid, and the sheet is manufactured.

For the substance soluble in acid, metal powders and inorganic compound powders can be used. Among them, at least one kind selected from the group consisting of nickel and calcium carbonate is preferably used. Furthermore, the powder characteristics of the particles for use have no particular limitations, but the average particle size thereof is preferably >0.1 μm and <5 μm, and more preferably >0.5 μm and <2 μm. The porosity of the catalyst layer increases together with the increase in pores of >0.1 μm and <10 μm by using the particles soluble in acid.

In process (d), for the solvent for dispersing the mixture X and the substance soluble in acid, an organic solvent such as tetrahydrofuran, dimethylformamide, dimethyl sulfoxide or N-methyl-2-pyrrolidone can be used.

Also, for the material of the sheet used in process (d), a polymeric film or metal foil can be used. When using a polymeric film, however, a problem is likely to occur such that the catalyst layer cracks due to the thermal shrinkage in the joining process, and that the film is insufficiently peeled off from the catalyst layer. When using a metal foil, a problem is likely to occur, depending on its material, such that the adsorption of a metal ion to a sulfonic acid group or the like of the cation exchange resin prevents a proton in the cation exchange resin from moving.

Accordingly, for the material of the sheet, a titanium film or titanium alloy film >10 μm and <100 μm thick is preferable. The reasons include the fact that the oxide film formed on the surface of the titanium film or titanium alloy film is so dense and chemically stable as to be impervious to the acid of the sulfonic acid group or the like contained in the cation exchange resin.

When the thickness of the titanium film or titanium alloy film is less than 10 μm, the film is possibly broken when applying the slurry. In contrast, when the thickness thereof exceeds 100 μm, the processing after applying the slurry and drying becomes difficult. Based on this standpoint, the thickness of the titanium film or titanium alloy film suitable for the manufacturing method of the present invention is >10 μm and <100 μm, and more preferably >15 μm and <50 μm.

For the method of applying the slurry onto the sheet in process (d), the coater head of an arbitrary method such as the reverse roll method, the comma bar method, the gravure method or the air knife method can be used. The application can also be carried out by the doctor blade method, the dip coating method or the like.

Also, for the drying method in process (d), in addition to exposure drying, an air blow dryer, a warm air dryer, an infrared heater, a far-infrared heater or the like can be used, but not being limited to a specific drying method.

In process (e) of the manufacturing method of the PEFC of the present invention, the cation exchange membrane-catalyst electrode assembly is preferably manufactured by joining a catalyst layer to the surface of the cation exchange membrane from the layered product of the catalyst layer containing the mixture X, a substance soluble in acid, and a sheet obtained in process (d).

For the cation exchange membrane, for example, a perfluoro sulfonic acid type resin or a cation exchange resin such as styrene-divinylbenzenesulfonic acid resin can be used. Furthermore, the cation exchange membrane may be made up of a carboxylic acid type cation exchange resin, being applicable for the present invention as long as the cation exchange membrane shows proton conductivity. More preferably, the cation exchange membrane made up of a perfluorocarbon sulfonic acid type resin whose chemical stability and proton conductivity are high, is used.

The joining in process (e) can be carried out by hot pressing. Its target temperature is preferably close to the glass-transition temperature of the cation exchange resin. However, the catalyst layer and the cation exchange membrane can be joined together by applying pressure at a temperature of 0° C. or higher, where water does not freeze up. For the joining, a flat press or roll press can be used.

In process (f) of the manufacturing method of the PEFC of the present invention, the substance soluble in acid contained in the catalyst layer is removed by bringing the cation exchange membrane-catalyst electrode assembly obtained in process (e) into contact with acid. The place from which the substance soluble in acid is removed becomes pores.

For the method of bringing the cation exchange membrane-catalyst electrode assembly into contact with acid, examples include the method by immersing the cation exchange membrane-catalyst electrode assembly in an acid solution for a prescribed period of time; and the method by spraying an acid solution on the cation exchange membrane-catalyst electrode assembly. It is to be noted that the type of acid is not limited to a specific kind in the present invention, but sulfuric acid or nitric acid is preferably used.

When using the cation exchange membrane-catalyst electrode assembly obtained by the manufacturing method of the present invention in the PEFC, a gas diffusion layer made of a conductive porous media such as carbon paper or carbon cloth is preferably positioned outside the anode and cathode of the cation exchange membrane-catalyst electrode assembly.

To the cathode and anode of the cation exchange membrane-catalyst electrode assembly, a gas containing oxygen and a gas containing hydrogen are supplied respectively. Specifically, gas to be fuel is supplied to the cation exchange membrane-catalyst electrode assembly by positioning a separator on which a groove to be a gas flow channel is formed, outside both electrodes of the cation exchange membrane-catalyst electrode assembly so as to flow the gas into the gas flow channel.

### EXAMPLES

Hereinafter, the present invention is described by way of preferred examples. The PEFC of the present invention was manufactured in the following methods.

### Example 1

(Process A) Firstly, 80.0 g cation exchange resin (Aldrich Corp., Nafion 5 mass % solution) was taken in a container. To the solution, 6.0 g Vulcan XC-72 (Cabot Corp.) was added as a carbon material and mixed together using a stirring rod. The dispersion thereof was prepared by stirring using a wing type stirrer for one hour applying ultrasonic wave. The dispersion was dried for 24 hours at 80° C. and then crushed so as to manufacture a mixture of the carbon material and the cation exchange resin.

(Process B) Next, 8.0 g mixture obtained in process A was immersed in 150 ml [Pt(NH₃)₄] Cl₂ solution adjusted to have a concentration of 50 mmol 1⁻¹ for six hours or longer so that [Pt(NH₃)₄]²⁺ was adsorbed to a proton conductive path of the cation exchange resin in the mixture. After that, the mixture was fully cleaned with deionized water and then dried in the air at 80° C.

(Process C) Next, the mixture obtained in process B was put in a reductor, and the reductor was then filled with hydrogen of 1 atm. The reductor was heated to 180° C. and maintained for 12 hours so that a catalyst metal was selectively loaded on the contact surface between the proton conductive path of the cation exchange resin and the surface of the carbon material. The mixture X containing the cation exchange resin, the carbon material and the catalyst metal was thus obtained. The reductor was cooled down to reach room temperature, and the mixture X was then taken out.

Furthermore, process B and process C were repeated twice.

(Process D) Next, 3.0 g mixture X obtained in process C, 7.0 g nickel particles as a substance soluble in acid (Nikko Rica Corp., average particle size 0.65 μm) and 40 g N-methyl-2-pyrrolidone were weighed and then mixed together with a stirring rod. Furthermore, by stirring using a wing type stirrer for one hour applying ultrasonic wave, a slurry for application was prepared. The slurry was applied using a doctor blade having a 220 μm gap onto a titanium film 50 μm thick and dried so as to obtain a layered product of a catalyst layer containing the mixture X and the nickel particles as a substance soluble in acid, and the titanium film.

(Process E) The layered product obtained in process D was brought into contact with the both sides of a cation exchange membrane made of a perfluorocarbon polymer having a sulfonic acid group (DuPont Corp., Nafion 115). This was hot-pressed (130° C., 100 kg cm⁻²) so as to join the cation exchange membrane and the catalyst layer together into one. After that, the titanium film was peeled off from the assembly so as to obtain a cation exchange membrane-catalyst electrode assembly containing nickel particles in its catalyst layer.

(Process F) The cation exchange membrane-catalyst electrode assembly obtained in process E was boiled for one hour in 0.5 M sulfuric acid so as to remove the nickel particles by dissolving. A cation exchange membrane-catalyst electrode assembly was thus obtained.

The obtained cation exchange membrane-catalyst electrode assembly had an area of 25 cm² in its electrode part. By each of the two catalyst layers joined to the assembly, 0.07 mg cm⁻² platinum was loaded as a catalyst metal. The PEFC having the assembly was taken as Example 1. It is to be noted that when one of the assemblies manufactured in such a method was used for obtaining the porosity of the catalyst layer, the porosity was 79%.

### Example 2

A cation exchange membrane-catalyst electrode assembly whose catalyst layer porosity was 70% and whose platinum amount per one catalyst layer was 0.10 mg cm⁻² was manufactured in a similar procedure to that of Example 1 except that the amount of nickel particles changed to 3.0 g; that the amount of N-methyl-2-pyrrolidone changed to 30 g; and that a doctor blade having a 200 μm gap was used for slurry application, in Process D. The PEFC having the assembly was taken as Example 2.

### Example 3

A cation exchange membrane-catalyst electrode assembly whose porosity was 85% and whose platinum amount per one catalyst layer was 0.05 mg cm⁻² was manufactured in a similar procedure to that of Example 1 except that the amount of nickel particles changed to 10.5 g; that the amount of N-methyl-2-pyrrolidone changed to 50 g; and that a doctor blade having a 240 μm gap was used for slurry application, in Process D. The PEFC having the assembly was taken as Example 3.

### Example 4

A cation exchange membrane-catalyst electrode assembly whose porosity was 74% and whose platinum amount per one catalyst layer was 0.06 mg cm⁻² was manufactured in a similar procedure to that of Example 1 except that calcium carbonate particles (Nitto Funka Kogyo KK, average particle size 1.85 μm) were used instead of nickel particles in Process D; and that 0.5M nitric acid was used in Process F. The PEFC having the assembly was taken as Example 4.

### Example 5

A cation exchange membrane-catalyst electrode assembly whose porosity was 65% and whose platinum amount per one catalyst layer was 0.11 mg cm⁻² was manufactured in a similar procedure to that of Example 1 except that the amount of nickel particles changed to 2.0 g; that the amount of N-methyl-2-pyrrolidone changed to 25 g; and that a doctor blade having a 190 μm gap was used for slurry application, in Process D. The PEFC having the assembly was taken as Example 5.

### Example 6

A cation exchange membrane-catalyst electrode assembly whose porosity was 88% and whose platinum amount per one catalyst layer was 0.04 mg cm⁻² was manufactured in a similar procedure to that of Example 1 except that the amount of nickel particles changed to 15 g; that the amount of N-methyl-2-pyrrolidone changed to 65 g; and that a doctor blade having a 250 μm gap was used for slurry application, in Process D. The PEFC having the assembly was taken as Example 6.

### Comparative Example 1

A cation exchange membrane-catalyst electrode assembly whose porosity was 58% and whose platinum amount per one catalyst layer was 0.12 mg cm⁻² was manufactured in a similar procedure to that of Example 1 except that the amount of nickel particles changed to 0 g; that the amount of N-methyl-2-pyrrolidone changed to 20 g; and that a doctor blade having a 175 μm gap was used for slurry application, in Process D. The PEFC having the assembly was taken as Comparative Example 1.

### Comparative Example 2

2.0 g platinum catalyst loaded carbon (Tanaka Kikinzoku Kogyo KK, platinum 50 mass % load: Vulcan XC72), 13.4 g cation exchange resin (Aldrich Corp., Nafion 5 mass % solution) and 8.0 g nickel particles (Nikko Rica Corp., average particle size 0.65 μm) were weighed and then mixed together with a stirring rod. Furthermore, by stirring using a wing type stirrer for one hour applying ultrasonic wave, a slurry for application was prepared. The viscosity of the mixture was adjusted by adding dimethyl sulfoxide to use the mixture as a dispersing liquid for applying onto the catalyst layer. A layered product of a catalyst layer containing nickel particles as a substance soluble in acid, and a titanium film was obtained by applying the dispersing liquid onto a titanium film 50 μm thick using a doctor blade having a 180 μm gap, and drying. Next, the layered product of the catalyst layer containing nickel particles and the titanium film was brought into contact with the both sides of a cation exchange membrane made of a perfluorocarbon polymer having a sulfonic acid group (DuPont Corp., Nafion 115) and then hot-pressed (130° C., 100 kg cm⁻²) so as to join the cation exchange membrane and the catalyst layer together into one. Finally, a cation exchange membrane-catalyst electrode assembly was obtained by boiling for one hour in 0.5 M sulfuric acid solution so as to remove nickel particles. In the catalyst electrode, the platinum amount per one catalyst layer was 0.80 mg cm⁻². The PEFC having the assembly was taken as Comparative Example 2. It is to be noted that when one of the cation exchange membrane-catalyst electrode assemblies thus manufactured was used for obtaining the porosity of the catalyst layer, the porosity was 74%.

### Comparative Example 3

A cation exchange membrane-catalyst electrode assembly whose porosity was 85% and whose platinum loading amount was 0.60 mg cm⁻² was manufactured in a similar procedure to that of Comparative Example 2 except that the amount of nickel particles changed to 10.7 g; and that a doctor blade having a 170 μm gap was used for slurry application. The PEFC having the assembly was taken as Comparative Example 3.

### Comparative Example 4

A cation exchange membrane-catalyst electrode assembly whose porosity was 88% and whose platinum loading amount was 0.56 mg cm⁻² was manufactured in a similar procedure to that of Comparative Example 2 except that the amount of nickel particles changed to 12.2 g; and that a doctor blade having a 190 μm gap was used for slurry application. The PEFC having the assembly was taken as Comparative Example 4.

### Comparative Example 5

A cation exchange membrane-catalyst electrode assembly whose porosity was 63% and whose platinum loading amount was 0.70 mg cm⁻² was manufactured in a similar procedure to that of Comparative Example 2 except that the amount of nickel particles changed to 6.5 g; that a doctor blade having a 140 μm gap was used for slurry application. The PEFC having the assembly was taken as Comparative Example 5.

### Comparative Example 6

A cation exchange membrane-catalyst electrode assembly whose porosity was 57% and whose platinum loading amount was 0.75 mg cm⁻² was manufactured in a similar procedure to that of Comparative Example 2 except that the amount of nickel particles changed to 0 g; and that a doctor blade having a 100 μm gap was used for slurry application. The PEFC having the assembly was taken as Comparative Example 6.

The current-voltage characteristics of the PEFCs thus obtained in Examples 1 to 6 and Comparative Examples 1 to 6 were measured. The measurement was carried out by supplying hydrogen (utilization factor: 80%)/air (utilization factor: 40%) at atmospheric pressure under a condition in which the cell temperature was 80° C.; the humidified temperature of anode gas was 80 ° C.; and the humidified temperature of cathode gas was 75° C. The current density per unit weight of a catalyst metal (the current density is hereinafter called as “mass activity”) was calculated by dividing the current value at a cell voltage of 0.75 V by the amount of the catalyst metal. The relation between the porosity of the catalyst layer and the mass activity in the PEFCs of Examples 1 to 6, Comparative Example 1 and Comparative Examples 2 to 6 is shown in FIG. 1, respectively. In FIG. 1, reference mark ◯ denotes the results of Examples 1 to 6 and Comparative Example 1, and reference mark Δ denotes the results of Comparative Examples 2 to 6. As can be seen from the results of reference mark ◯, the mass activity within the range in which the porosity of the catalyst layer is >65% and <87.5% significantly improves compared to those of other ranges. It is conceivable that the decreases in gas diffusibility and in expelling property of generated water in the catalyst layer caused increase in polarization when the porosity of the catalyst layer was less than 65%. In contrast, when the porosity of the catalyst layer exceeded 87.5%, it is conceivable that the contact resistance between carbon materials increased thereby increasing the polarization of the PEFC. Furthermore, it can be seen, by contrast between reference marks ◯ and Δ in FIG. 1, that the effect of the porosity of the catalyst layer remarkable only within a defined range was obtained only at the electrode which had a catalyst layer selectively loading a catalyst metal on the contact surface between the proton conductive path of the cation exchange resin and the surface of the carbon material, whereas such a remarkable effect was not obtained at the electrode which used platinum catalyst loaded carbon (carbon which loads platinum catalyst). This is conceivably caused by the difference in structure between the electrode of the present invention and the electrode using platinum catalyst loaded carbon. In the electrode which uses carbon where platinum catalyst is previously loaded, a convex part is formed on the carbon by the platinum catalyst. It is conceivable that since the cation exchange resin is viscous, the entire convex part having fine projections due to the catalyst cannot be coated completely when coating the carbon. As a result, a part which is not coated by the cation exchange resin is created on the carbon surface around the convex part. Specifically, a clearance is created around the catalyst. Consequently, there exists a space adjacent to the catalyst, into which gas can diffuse and generated water is discharged. Conceivably, reaction gas reaches the catalyst through the space, and water generated by reaction is discharged also through the space. On the other hand, when a catalyst is selectively loaded on the contact surface between the proton conductive path of the cation exchange resin and the surface of the carbon material, the carbon is coated by the cation exchange resin before the catalyst is loaded on the carbon. After that, since the catalyst metal is selectively loaded on the contact surface between the proton conductive path of the cation exchange resin and the surface of the carbon material, a large clearance is not created around the catalyst metal. Specifically, reaction gas has to pass through the proton conductive path filled with water in order to reach the catalyst. Consequently, it is conceivable that in the case that a catalyst is selectively loaded on the contact surface between the proton conductive path of the cation exchange resin and the surface of the carbon material, effect of gas diffusion and generated water retension is stronger in comparison with the case using the carbon where platinum is previously loaded. Specifically, it can be seen that the remarkable effect obtained by controlling the porosity of the catalyst layer within a defined range by the present invention cannot be obtained by the electrode which uses the carbon where platinum catalyst is previously loaded, but can obtained only when a catalyst is selectively loaded on the contact surface between the proton conductive path of the cation exchange resin and the surface of the carbon material. Therefore, in the present invention in which a catalyst is selectively loaded on the contact surface between the proton conductive path of the cation exchange resin and the surface of the carbon material, in order to maintain the gas diffusibility, water expelling property and electronic conductivity in the catalyst layer at a high level, the porosity of the catalyst layer has to be >65% and <87.5%, more preferably >70% and <85%.

This application is based on the Japanese Patent Application No. 2004-083366 filed on Mar. 22, 2004. The entire disclosure of the specification is incorporated herein by reference.

1. A polymer electrolyte fuel cell comprising:
a catalyst layer;
a cation exchange resin provided in said catalyst layer;
a proton conductive path provided in said cation exchange resin;
a carbon material provided in said catalyst layer; and
a catalyst metal provided in said catalyst layer,
wherein 50 mass % or more of said catalyst metal is loaded on a contact surface between said proton conductive path and said carbon material, and
a porosity of said catalyst layer is 65% to 87.5%.

2. The polymer electrolyte fuel cell according to claim 1, wherein the porosity of said catalyst layer is 70% to 85%.

3. The polymer electrolyte fuel cell according claim 1, wherein said catalyst metal contains a platinum group metal.

4. The polymer electrolyte fuel cell according to claim 2, wherein said catalyst metal contains a platinum group metal.

5. A manufacturing method of the polymer electrolyte fuel cell according to claim 1, comprising the steps of:
a first process for adsorbing a cation of the catalyst metal to a fixed ion of said cation exchange resin in a mixture of the carbon material and the cation exchange resin;
a second process for reducing said cation after said first process so as to manufacture a mixture X which contains said cation exchange resin, said carbon material and said catalyst metal;
a third process for curing a slurry which contains said mixture X, a substance soluble in acid and a solvent, applied onto a substrate after said second process so as to manufacture a layered product of a catalyst layer containing said substance, and said substrate;
a fourth process for joining said catalyst layer to a cation exchange membrane after said third process so as to manufacture an assembly of said cation exchange membrane and a catalyst electrode; and
a fifth process for bringing said catalyst layer into contact with acid after said fourth process so as to dissolve said substance.

6. The manufacturing method of the polymer electrolyte fuel cell according to claim 5, wherein said substance comprises metal powder or inorganic compound powder.

7. The manufacturing method of the polymer electrolyte fuel cell according to claim 5, wherein said substance comprises nickel powder or calcium carbonate powder.

8. The manufacturing method of the polymer electrolyte fuel cell according to claim 5, wherein said acid in said fifth process comprises sulfuric acid or nitric acid.

9. The manufacturing method of the polymer electrolyte fuel cell according to claim 5, wherein said cation of said catalyst metal in said first process contains a platinum group metal.

10. A manufacturing method of the polymer electrolyte fuel cell comprising the steps of:
a first process for substituting a cation of a catalyst metal for a cation exchange resin having a fixed anion bonded with a hydrogen ion and said hydrogen ion in a mixture with a carbon material, in a solution;
a second process for decreasing a hydrogen ion concentration of said solution after said first process;
a third process for reducing said cation after said first process so as to manufacture a mixture X containing said cation exchange resin, said carbon material and said catalyst metal;
a fourth process for curing a slurry which contains said mixture X, a substance soluble in acid and a solvent, applied onto a substrate after said second and third processes so as to manufacture a layered product of a catalyst layer containing said substance, and said substrate;
a fifth process for joining said catalyst layer to a cation exchange membrane after said fourth process so as to manufacture an assembly of said cation exchange membrane and a catalyst electrode; and
a sixth process for bringing said catalyst layer into contact with acid after said fifth process so as to dissolve said substance.

11. The manufacturing method of the polymer electrolyte fuel cell according to claim 10, wherein said substance comprises metal powder or inorganic compound powder.

12. The manufacturing method of thepolymer electrolyte fuel cell according to claim 10, wherein said substance comprises nickel powder or calcium carbonate powder.

13. The manufacturing method of the polymer electrolyte fuel cell according to claim 10, wherein said acid in said sixth process comprises sulfuric acid or nitric acid.

14. The manufacturing method of the polymer electrolyte fuel cell according to claim 10, wherein said cation of said catalyst metal in said first process contains a platinum group metal.
